(19) United States
(12) Patent Application Publication
(10) Pub. No.: US 2004/0232716 A1
(43) Pub. Date: Nov. 25, 2004

(54) Gripping apparatus with two fingers covered by a movable film

(76) Inventors: John N Reed, Beds (GB); Simon J Miles, Bedford (GB)

Correspondence Address: Bradley N Ruben, Suite 5A, 463 First St, Hoboken, NJ, 07030-1859, US

(21) Appl. No.: 10/485,504

(22) PCT Filed: Jul. 25, 2002
(86) PCT No.: PCT/GB02/03416

(30) Foreign Application Priority Data
Jul. 30, 2001 (GB) 0118545.3

(51) Int. Cl. B25J 15/08

(52) U.S. Cl. 294/86.4; 294/119.1

(57) ABSTRACT

A gripping apparatus for pick and place handling of articles, wherein the apparatus comprises: a supporting frame (100); and a pair of gripping fingers (2a, 2b) mounted directly or indirectly to the supporting frame and moveable towards each other so as to grip an article (3) therebetween or moveable apart for conventional release of the article, each finger being faced with a respective facing material web (7a, 7b) which is powered to be moveable over the surface of the finger, whereby an article gripped between the gripping fingers may be picked up, released and/or moved therealong, in use, by movement of the facing material webs and independently of movement of the grippping fingers toward or away from each other.

### FIELD OF THE INVENTION

The present invention concerns improvements in and relating to gripping apparatus for picking up and placement of articles and is particularly relevant to pick and place handling of sticky or tacky articles or articles to be moved from and/or into tightly confined locations such as recessed packaging compartments. A primary use for the method and apparatus of the present invention is in handling of a wide range of bare food products for packaging them.

### BACKGROUND TO THE INVENTION

Handling of bare, i.e. unwrapped, food products in preparation and packaging of the products, especially where they are sugar-coated or for other reasons substantially sticky/tacky on their external surfaces, is notoriously difficult to efficiently automate. A major problem with handling of such products as iced cakes, glazed cherries, chocolate enrobed products and other confectionery items, is that an automated handling system seeking to use grippers to pick up each product for transfer and deposition, faces the difficulty of cleanly discharging the product. The product will generally adhere to the gripper fingers at least temporarily when released, leading to inaccurate placement of the product and disruption of synchronous running of an automated production line. Furthermore, tacky surface coating from the product may begin to build up as a residue on the gripper assembly, contrary to the requirements for strict hygiene during food production and packaging.

Largely for these above reasons, the food industry generally relies upon manual pick and place handling of the food products. This is, of course, inherently very labour intensive and costs the food industry billions of pounds per year in labour.

Whereas automation of production in the automotive industry now appears to be approaching maturity and the major robot manufacturers are interested in applying their technology to the food industry as a significant new area of opportunity, their ability to address the needs of the food industry is severely limited by the inadequacies of the currently available end-effectors for handling of food articles.

### SUMMARY OF THE INVENTION

According to a first aspect of the present invention there is provided a gripping apparatus for pick and place handling of articles, wherein the apparatus comprises:

a supporting frame; and

a pair of gripping fingers mounted directly or indirectly to the supporting frame and moveable towards each other so as to grip an article therebetween or moveable apart for conventional release of the article, each finger being faced with a respective facing material web which is powered to be moveable over the surface of the finger, whereby an article gripped between the gripping fingers may be picked up, released and/or moved therealong, in use, by movement of the facing material webs and independently of movement of the gripping fingers toward or away from each other.

Preferably, the gripping fingers have actuator means by means of which the gripping finger is extended and retracted and wherein the gripped article between the gripper fingers, is released without substantially opening the gripper fingers by moving, in use, the facing material web in an opposite direction to a retracting movement of the gripper fingers. The oppositely directed motion of the web for release is suitably equal in extract to the retraction motion of the gripping fingers, whereby the article may be released from the gripping fingers with out being retracted/raised by the retracting fingers. A gripped article may thus be released while remaining held against a surface and even in a confined space such as a packing pocket

Preferably the facing material web of each gripping finger is in the form of a tape or band which is mounted at one end to a tensioning spool, which spool is powered to wind up the respective facing tape or band.

Advantageously the powered tensioning spool is powered by a resilient biasing means, for example a spring coil. This is most useful where the gripping fingers are powered to extend and retract, providing a simple and efficient means for causing equal and oppositely directed motion of the tape or band relative to the finger.

The tensioning spool may alternatively be motorised. With a motorised spool at at least one end of the tape or band, and resilient biassing means or motorised spool at the other end, the tape or band may be drawn in either direction of motion and the operation of the gripping apparatus need not rely on powered extension/retraction of the gripping fingers.

Preferably the tape or band is mounted at one end to the spool and at the other end to an anchoring point.

Advantageously each gripping finger has a respective actuator, e.g. piston and cylinder or rack and pinion, by means of which the gripping finger is extended and retracted.

Each actuator is suitably mounted together with the tensioning spool and the anchoring point of the tape or band on a support module, each finger having its own respective support module, the support modules being movable toward or away from each other for movement of the fingers toward or away from each other.

Preferably each gripping finger comprises a gripping plate which is mounted to one end of an actuator, e.g. to the end of the piston rod of a piston and cylinder or the rack of a rack and pinion.

Preferably the tape or band of facing material web passes over the internal/gripping major face of the respective gripping finger, around the tip of the gripping finger and then back up over the obverse face of the gripping finger.

Advantageously the tip of the gripping finger is rounded and suitably radiused or provided with a bearing to reduce frictional resistance on the tape or band as it moves around the finger tip.

Preferably the anchoring point is comprised in a tape or band feed mechanism that is adapted to index forward at intervals to provide a fresh length of tape or band to extend at least over part of the gripping finger.

Preferably the indexing feed mechanism is a motorised spool and the tensioning spool is also a motorised spool.

Preferably the apparatus is adapted for self-cleaning of the facing material web, having a cleaning head adjacent the web to clean it as it passes thereby.

According to a further aspect of the present invention there is provided a gripping head for a gripping apparatus and comprising a pair of gripping fingers which are movable towards each other so as to grip an article therebetween or movable apart for conventional release of the article, each finger being faced with a respective facing material web which is powered to be movable over the surface of the finger, whereby an article gripped between the gripping fingers may be picked up, released and/or moved therealong, in use, by a movement of the facing material webs and independently of movement of the gripping fingers toward or away from each other.

According to a yet further aspect of the present invention there is provided a gripping finger for a gripping apparatus and having a facing material web extending over a gripping surface of the finger and which is powered to be moveable over the surface of the finger.

### BRIEF DESCRIPTION OF THE DRAWINGS

A preferred embodiment of the present invention will now be more particularly described, by way of example, with reference to the accompanying drawings, wherein:

FIG. 1 is a simple schematic diagram of the gripping head of the gripping apparatus of the present invention with the gripping fingers of the gripping head substantially surrounding the sides of the gripped article;

FIG. 2 is a view similar to FIG. 1 but with the gripping head retracted and close to the point of release of the gripped article;

FIG. 3 is a schematic general assembly view of the gripping apparatus; and

FIG. 4 is a perspective view of the gripping head of the gripping apparatus.

### DESCRIPTION OF THE PREFERRED EMBODIMENT

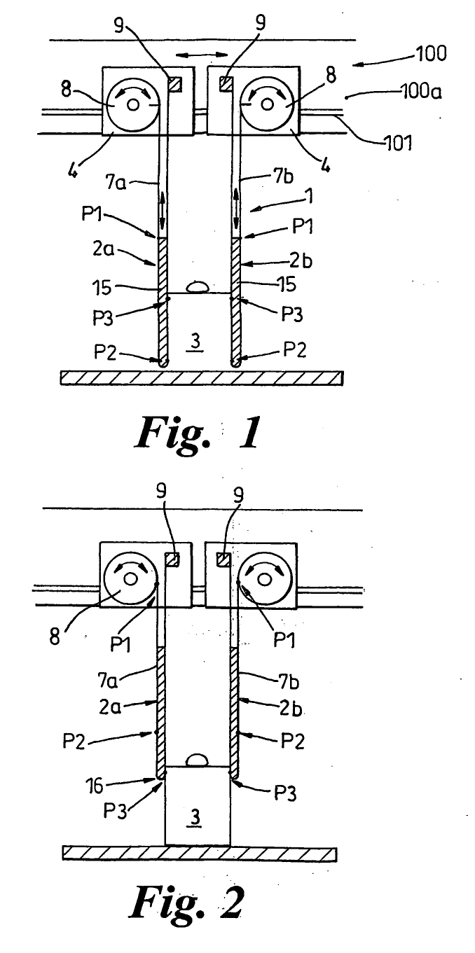

Referring to FIGS. 1 to 4, the illustrated embodiment of apparatus of the present invention comprises a general supportive framework 100 having a beam 100a from which depends a gripping head 1. The gripping head 1 comprises a pair of opposing gripping members or fingers, 2a, 2b, that are assembled to the beam 100a to reciprocate together in a substantially recti-linear clamping motion to clamp an article such as a fairy cake 3 or a glace cherry 3′ between them.

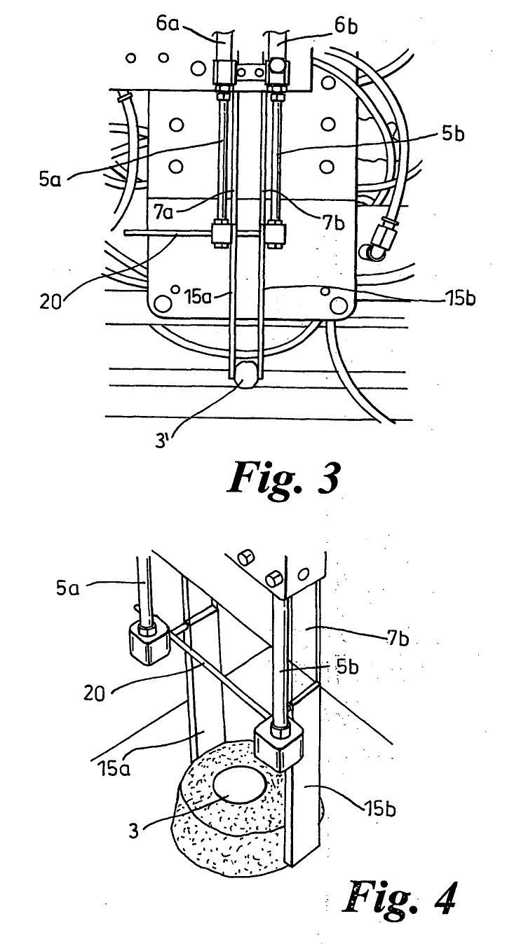

The gripping fingers 2a, 2b are mounted extending substantially vertically downwardly from the ends of a substantially mutually parallel pair of substantially vertically arranged piston rods 5a, 5b (FIGS. 3 and 4). The piston rods 5a, 5b reciprocate substantially vertically such that with downward advancement they may pick up and place down the article 3, 3′ and when raised may be moved to a different location.

The piston rods 5a, 5b, each extend from a respective one of a pair of piston cylinders 6a, 6b which are each mounted to a respective support module 4 that is configured to move along a track 101 on the beam 100a for movement of the gripping fingers 2a, 2b together or apart. A linking rod 20 links the lower ends of the piston rods 5a, 5b to keep the fingers in, a rigidly parallel spaced configuration as the fingers 2a, 2b move together or apart.

The beam 100a, in turn, Is suitably moveable and serves as part of a transport carriage on the frame 100 for transfer of the article 3, 3′ to a desired location for deposition. In one simple arrangement the beam 100a may be mounted on its own rails (not shown) to move along a straight axis fore and aft or side-to-side of the frame 100.

The gripping fingers 2a, 2b are of a specialised construction. In the illustrated embodiment, they comprise a pair of substantially rectangular plates 15a, 15b, suitably of a metal or metal alloy or rigid and robust plastics material. These plates 15a, 15b are each faced with a respective thin tape/band 7a, 7b that is slidingly moveable over the surface of the plate 15a, 15b. Each facing tape 7a, 7b is suitably of cellophane or acetate or other plastics polymer that is food grade, i.e. safe for use with food and may, for example, resemble an adhesive tape such as Sellotape® but is adhesive free. It extends at one end from a spring-loaded or motorised spool 8 and passes down the outer major face of the plate 15a, 15b to which it is mounted and around the radiused tip 16 of the plate 15 and then extends back up the inside (i.e. gripping) face of the plate 15 to be anchored by an anchoring mount 9.

The anchoring mount 9 is illustrated as a static block but in an alternative preferred embodiment (not illustrated) may comprise a spool that is adapted to be indexed forward to feed fresh lengths of tape 7a, 7b to extend over the fingers 2a, 2b. The spring loaded or motorised tensioning spool 8 and the anchoring mount 9 are both located on the support module 4.of the respective gripper finger 2a, 2b so that each finger 2a, 2b is self-contained, complete with its facing tape 7a, 7b and tape tensioning/drive mechanism—spool 8 and, 6 anchor mount 9. Accordingly, whether the respective modules 4, and hence fingers 2a, 2b are moving together or apart or not, the facing tapes 7a, 7b of the fingers 2a, 2b can operate, sliding over the surfaces of the fingers 2a, 2b.

In a typical grip and release cycle the fingers 2a, 2b extend pulling the tapes 7a, 7b out from their spools 8.

Once extended the fingers 2a, 2b can then be closed together to grip an article 3. To release an article 3 (without opening the fingers 2a, 2b) the fingers 2a, 2b are simultaneously withdrawn towards the beam of the gripper frame 100a. This does not cause the article 3 to move since its only contact with the finger 2a, 2b is through the anchored (non-moving) side of the tape 7a, 7b. As the finger 2a, 2b withdraws the tape 7a, 7b on the outside of the finger 2a, 2b it is wound up around the finger tip 16. The continuously held object 3 effectively ‘emerges’ from the end of the withdrawing fingers 2a, 2b until it is released as the contacting tape 7a, 7b is peeled away from it around the finger tip radius 16.

FIGS. 1 and 2 show an example action of deposition of an article without substantial movement apart of the fingers 2a, 2b.

Referring to FIG. 1, the gripping fingers 2a, 2b are shown gripping an article 3, such as a fairy cake between them. The position of three-selected reference points on each of the tapes 7a, 7b are highlighted as P1 to P3. A comparison of FIG. 1 with FIG. 2 will reveal that these points have shifted in the FIG. 2 view, the tapes 7a, 7b having been reeled in by their respective motorised or spring-loaded tensioning spool 8. The tapes 7a, 7b are reeled in upwardly (onto the tensioning spool 8 as the pistons 5a, 5b are retracted and are reeled in at twice the rate of the retraction of the pistons 5a, 5b (they have twice the piston/finger distance to travel). As a result the cake 3 is gradually released from the gripper.

It will be appreciated that, since the expulsion of the cakes 3 occurs without needing to move the gripper fingers 2a, 2b apart, the cake 3 can be reliably placed accurately and precisely into a narrow packaging space such as a cup-shaped recess in a thermoformed plastics packaging tray. Stickiness/tackiness of the cake does not disrupt accuracy of the placement. Conversely pickup of the cake 3 may also be achieved from such a confined space with only minimal opening of the fingers 2a, 2b to position the cake 3 between them. This may be especially useful where only part of the cake 3 or other article is protruding from the confined space and, to get a better grip, the movement of the tapes 7a, 7b is used to tractor the article up more fully between the fingers 2a, 2b.

The ability of the apparatus to operate within confined spaces makes it potentially of great use not only in the food industry but also in the likes of the pharmaceutical industry and electronics industry.

The pick and place handling is carried out with great efficiency and the renewing supply of tape from an indexed supply reel in place of the anchoring block 9 eliminates the potential build up of food residue on the fingers 2a, 2b. By way of alternative to fed renewal of the tape, the apparatus could be self-cleaning by incorporating a tape cleaning head, for example having a brush to remove food residue as the tape passes.

1. A gripping apparatus for pick and place handling of articles, wherein the apparatus comprises:
a supporting frame; and
a pair of gripping fingers mounted directly or indirectly to the gripping frame and moveable towards each other so as to grip an article therebetween or moveable apart for conventional release of the article, each finger being faced with a respective facing material web which is powered to be moveable over the surface of the finger, whereby an article gripped between the gripping fingers may be picked up, released and/or moved therealong, in use, by movement of the facing material webs and independently of movement of the gripping fingers toward or away from each other.

2. A gripping apparatus as claimed in claim 1, wherein the gripping fingers have actuator means by means of which the gripping finger is extended and retracted and wherein the gripped article between the gripper fingers, is released without substantially opening the gripper fingers, by moving, in use, the facing material web in an opposite direction to a retracting movement of the gripper fingers.

3. A gripping apparatus as claimed in claim 1, wherein the facing material web of each gripping finger is in the form of a tape or band which is mounted at one end to a tensioning spool, which spool is powered to wind up the respective facing tape or band.

4. A gripping apparatus as claimed in claim 3, wherein the powered tensioning spool is powered by a resilient biasing means.

5. A gripping apparatus as claimed in claim 3 wherein said powered tensioning spool is powered by a motor or the apparatus has a further spool at the other end of the tape or band and which is powered by a motor.

6. A gripping apparatus as claimed in claim 3, wherein the tape or band is mounted at one end to the spool and at the other end to an anchoring point.

7. A gripping apparatus as claimed in claim 2, wherein each gripper finger has its own respective actuator and each actuator is mounted together with the tensioning spool and the anchoring point of the tape or hand on a support module, each finger having its own respective support module, the support modules being movable toward or away from each other for movement of the fingers toward or away from each other.

8. A gripping apparatus as claimed claim 1, wherein each gripping finger comprises a gripping plate which is mounted to one end of an extendable actuator.

9. A gripping apparatus as claimed in any preceding claim, wherein the tape or band of facing material web passes over the internal gripping major face of the respective gripping finger, around the tip of the gripping finger and then back up over the obverse face of the gripping finger.

10. A gripping apparatus as claimed in claim 9, wherein the tip of the gripping finger is rounded and suitably radiused or provided with a bearing to reduce frictional resistance on the tape or band as it moves around the finger tip.

11. A gripping apparatus as claimed in claim 6, wherein the anchoring point is comprised in a tape or band feed mechanism that is adapted to index forward at intervals to provide a fresh length of tape or band to extend at least over part of the gripping finger.

12. A gripping apparatus as claimed in claim 10 wherein the indexing feed mechanism is a motorised spool and the tensioning spool is also a motorised spool.

13. A gripping head for a gripping apparatus and comprising a pair of gripping fingers which are movable towards each other so as to grip an article therebetween or movable apart for conventional release of the article, each finger being faced with a respective facing material web which is powered to be movable over the surface of the finger, whereby an article gripped between the gripping fingers may be picked up, released and/or moved therealong, in use, by movement of the facing material webs and independently of movement of the gripping fingers toward or away from each other.

14. A gripping finger for a gripping apparatus and having a facing material web extending over a gripping surface of the finger and which is powered to be moveable over the surface of the finger.
